(19) United States
(12) Patent Application Publication
(10) Pub. No.: US 2011/0255296 A1
(43) Pub. Date: Oct. 20, 2011

(54) AIRCRAFT CEILING MODULE WITH INTEGRATED LIGHTING, VALENCES AND WIRING

(75) Inventors: Frank E. HASHBERGER, Snohomish, WA (US); Sylvio A. C. BRAVETTI, Brier, WA (US)

(73) Assignee: BE INTELLECTUAL PROPERTY, INC., Wellington, FL (US)

(21) Appl. No.: 13/089,229

(22) Filed: Apr. 18, 2011

Related U.S. Application Data
(60) Provisional application No. 61/326,162, filed on Apr. 20, 2010.

(51) Int. Cl. B64D 47/02

(52) U.S. Cl. 362/471

(57) ABSTRACT

An aircraft ceiling module includes a ceiling panel with integrated lighting, valences and wiring. LED lighting units are mounted directly to the ceiling panel, and one or more valence panels are connected to the ceiling panel to shield the LED lighting units. The valence panels are integral to the ceiling panel, and provide structural stiffness to overall construction of the ceiling module. Wiring connected to the LED lighting units is integrated into the ceiling panel.

### CROSS-REFERENCES TO RELATED APPLICATIONS

This application is based upon and claims priority from Provisional Patent Application No. 61/326,162, filed Apr. 20, 2010, which is incorporated by reference in its entirety herein.

### BACKGROUND OF THE INVENTION

The present invention generally relates to interior illumination for aircraft, and more particularly relates to an aircraft ceiling module with integrated lighting, valences and wiring.

Aircraft ceiling panels have traditionally been designed as a single-purpose component independent of adjacent components. In order to limit direct visibility of light sources it is necessary to provide separate additional decorative lenses over the lighting components. It would be desirable to provide an aircraft ceiling module with integrated lighting, valences and wiring to ensure proper alignment of the lighting, valences and ceiling panel through their integration into a single unit. It would also be desirable to provide ceiling panels with light valences incorporated into the ceiling panels in order to eliminate the requirement to have separate additional decorative lenses over lighting components. It would also be desirable to provide for the embedding of required wiring into a lay-up or ceiling panel construction, in order to eliminate the need for additional brackets and resultant potential chafing. The present invention meets these and other needs.

### SUMMARY OF THE INVENTION

Briefly, and in general terms, the present invention provides for an aircraft ceiling module with integrated lighting, valences and wiring. The advantages of the present invention are to ensure proper alignment of the lighting, valences and ceiling panel through their integration into a single unit. The present invention provides for the proper alignment of lighting to adjacent surfaces because the lighting is fixed integrally to a long and broad ceiling panel and, as a result, the small differences encountered in the installation location of adjacent parts will only result in a very small angular variation in the alignment of the lighting and valances to adjacent surfaces.

The present invention also provides for the rapid installation as a single modular unit of what are multiple separate components in the prior art. In addition, including light valences into the ceiling panels eliminates the requirement of providing separate additional decorative lenses over lighting components. The present invention also provides for the embedding of required wiring into the lay-up or the ceiling panel construction, eliminating brackets and potential chafing. Pre-installing lighting on ceiling panels according to the invention will also allow faster installation of interiors by pre-aligning the lighting, and pre-installed wiring simplifies the interfaces to the aircraft to also allow faster installation on the aircraft.

Accordingly, the present invention provides for an aircraft ceiling module with integrated lighting, valences and wiring. The ceiling module includes a ceiling panel, one or more LED lighting units mounted directly to the ceiling panel, and one or more valence panels connected to the ceiling panel and disposed in spaced relationship to the one or more LED lighting units to shield the one or more LED lighting units, to limit direct visibility of the one or more LED lighting units. In one presently preferred aspect, the one or more valence panels are integral to the ceiling panel. In another presently preferred aspect, the one or more valence panels can be mounted directly to the ceiling panel. In another presently preferred aspect, the ceiling module includes wiring connected to the one or more LED lighting units, and the wiring is integrated into the ceiling panel. In another presently preferred aspect, the one or more valence panels contribute structural stiffness to overall construction of the ceiling module.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a schematic diagram of an aircraft ceiling module with integrated lighting, valences and wiring according to the invention.

### DETAILED DESCRIPTION OF THE PREFERRED EMBODIMENTS

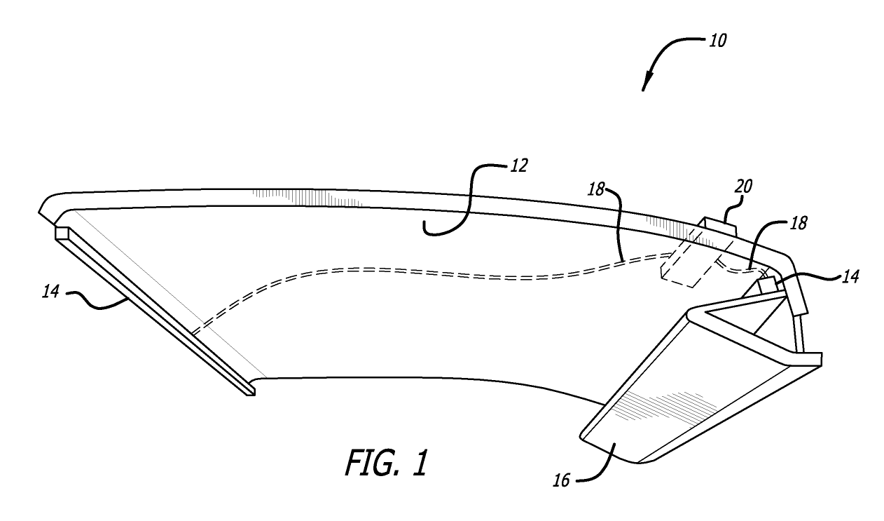

Referring to FIG. 1, which is provided by way of example, and not by way of limitation, the present invention provides for an aircraft ceiling module 10 with integrated lighting, valences and wiring. The ceiling module includes a ceiling panel 12, one or more LED lighting units 14 mounted directly to the ceiling panel, and one or more valence panels 16 connected to the ceiling panel and disposed in spaced relationship to the one or more LED lighting units to shield one or more of the LED lighting units. The one or more valence panels preferably are integral to the ceiling panel. Alternatively, the one or more valence panels can be mounted directly or indirectly to the ceiling panel.

The ceiling module preferably includes electrical wiring 18 connected to the one or more LED lighting units, and the electrical wiring is preferably integrated into the ceiling panel and electrically connected to one or more electrical connectors 20. The one or more electrical connectors are preferably integrated into the ceiling panel and are configured to be electrically connected to receive electrical power supplied by the aircraft. The one or more valence panels provide structural stiffness to overall construction of the ceiling module.

It will be apparent from the foregoing that while particular forms of the invention have been illustrated and described, various modifications can be made without departing from the spirit and scope of the invention. Accordingly, it is not intended that the invention be limited, except as by the appended claims.

We claim:

1. A ceiling module for an aircraft, comprising:
a ceiling panel;
at least one LED lighting unit mounted directly to said ceiling panel; and
at least one valence panel connected to said ceiling panel and disposed in spaced relationship to said at least one LED lighting unit to shield said at least one LED lighting unit.

2. The ceiling module of claim 1, wherein said at least one valence panel is integral to said ceiling panel.

3. The ceiling module of claim 1, wherein said at least one valence panel is mounted directly to said ceiling panel.

4. The ceiling module of claim 1, further comprising electrical wiring connected to said at least one LED lighting unit, and wherein said electrical wiring is integrated into the ceiling panel.

5. The ceiling module of claim 4, further comprising at least one electrical connector electrically connected to said electrical wiring and configured to be electrically connected to receive electrical power supplied by the aircraft.

6. The ceiling module of claim 5, wherein said at least one electrical connector is integrated into the ceiling panel.

7. The ceiling module of claim 2, wherein said at least one valence panel provides structural stiffness to overall construction of said ceiling module.

8. A ceiling module for an aircraft, comprising:
a ceiling panel;
electrical wiring integrated into said ceiling panel;
at least one electrical connector electrically connected to said electrical wiring and configured to be electrically connected to receive electrical power supplied by the aircraft;
at least one LED lighting unit mounted directly to said ceiling panel and electrically connected to said electrical wiring; and
at least one valence panel connected to said ceiling panel and disposed in spaced relationship to said at least one LED lighting unit to shield said at least one LED lighting unit.

9. The ceiling module of claim 8, wherein said at least one valence panel is integral to said ceiling panel.

10. The ceiling module of claim 8, wherein said at least one valence panel is mounted directly to said ceiling panel.

11. The ceiling module of claim 8, wherein said at least one electrical connector is integrated into the ceiling panel.

12. The ceiling module of claim 8, wherein said at least one valence panel provides structural stiffness to overall construction of said ceiling module.

13. A ceiling module for an aircraft, comprising:
a ceiling panel;
at least one LED lighting unit mounted directly to said ceiling panel; and
at least one valence panel connected to said ceiling panel and disposed in spaced relationship to said at least one LED lighting unit to shield said at least one LED lighting unit, wherein said at least one valence panel is integral to said ceiling panel.

14. The ceiling module of claim 13, further comprising electrical wiring connected to said at least one LED lighting unit, and wherein said electrical wiring is integrated into the ceiling panel.

15. The ceiling module of claim 14, further comprising at least one electrical connector electrically connected to said electrical wiring and configured to be electrically connected to receive electrical power supplied by the aircraft.

16. The ceiling module of claim 15, wherein said at least one electrical connector is integrated into the ceiling panel.

17. The ceiling module of claim 13, wherein said at least one valence panel provides structural stiffness to overall construction of said ceiling module.
